(19) United States
(12) Patent Application Publication
(10) Pub. No.: US 2026/0242291 A1
(43) Pub. Date: Aug. 20, 2026

(54) MICROPOROUS POWDER COMPOSITION, USE THEREOF AND INSULATION PRODUCT

(71) Applicant: PRTC NV, Tisselt (BE)

(72) Inventor: Oras ABDUL-KADER, Sint Niklaas (BE)

(21) Appl. No.: 19/469,434

(22) PCT Filed: Mar. 28, 2024
(86) PCT No.: PCT/EP2024/058672

§ 371 Date: Sep. 26, 2025

(30) Foreign Application Priority Data
Mar. 31, 2023 (EP) 23166012.7
Feb. 6, 2024 (EP) 24155918.6

(51) Int. Cl. C04B 35/14; C04B 35/626; F16L 59/02

(52) U.S. Cl. CPC C04B 35/14; C04B 35/62695; F16L 59/02; C04B 2235/3418; C04B 2235/3826; C04B 2235/5276; C04B 2235/5296; C04B 2235/5436; C04B 2235/608; C04B 2235/9607

(57) ABSTRACT

The microporous powder composition, comprising an insulation powder chosen from alumina and silica, and an opacifier and a filler, wherein the filler is a gypsum material. The gypsum material may be gypsum dihydrate, gypsum hemihydrate or gypsum anhydrite. It may be synthetic gypsum or natural gypsum or a combination of both. The microporous powder composition comprises the opacifier in an amount of 10-50 wt %, the insulation powder in an amount of 40-80 wt % and the filler in an amount of 1-50 wt %. The microporous powder composition is used in insulation products, such as granulates.

### FIELD OF THE INVENTION

The invention relates to a microporous powder composition, comprising an insulation powder chosen from alumina and silica, an opacifier and a filler.
The invention further relates to an insulation product comprising a microporous powder composition.
The invention moreover relates to the use of a microporous powder composition 8 for the manufacture of an insulation product.

### BACKGROUND OF THE INVENTION

Microporous insulation materials are known per se, for instance from GB1580909 and U.S. Pat. No. 6,936,326, and comprise a porous silica material which generally is either a pyrogenic silica or aerogel, and in addition thereto an opacifier and optionally a reinforcing fiber. In ASTM C168, microporous insulation is defined as “material in the form of compacted powder or fibres with an average interconnecting pore size comparable or below the mean free path of air molecules at standard atmospheric pressure. Microporous insulation may contain opacifiers to reduce the amount of radiant heat transmitted”. Microporous materials are characterized by a very low thermal conductivity of less than 40 mW/m·K and even significantly lower and are often used as thin insulating panel in a variety of industrial applications as well as in construction. In the context of the present application, reference will be made to a microporous powder composition as a synonym for a microporous insulation material.

The microporous insulation materials may be encapsulated in a rigid or flexible envelope. Such enveloped insulation product can be an insulation panel or the like. The microporous material may alternatively be provided within a barrier material which is then drawn to vacuum. The latter panel is known per se as a vacuum insulation panel or VIP. A further insulation product comprising microporous material is a granulate. The granules offer the advantage that these can fill up a space of any complex shape and act therein as insulating material. This turns out advantageous in applications such as heaters, fuel cells and other thermal apparatus, wherein a certain part of the apparatus will operate at relatively high temperature, typically between 300 and 1000° C., while other portions of the apparatus should not heat up too much, for instance to avoid any burning by a user. The granules may here be inserted into channels, cavities and other shapes so as to enable appropriate insulation.

Microporous powder compositions for the preparation of granulates are known from WO2006/097668A1. The disclosed compositions are fiber-free, as fibers result in relatively large voids between the granules. Such relatively large voids (as compared to the microporous voids within a microporous powder) would cause the thermal conductivity of the resulting material to be high relative to large continuous bodies of comparable insulation. The granulates were prepared on the basis of a powder composition comprising 30-95% dry weight microporous insulating material (i.e. pyrogenic silica), 5-70% dry weight infrared opacifying material, 0-50% particulate insulating filler material, and 0-5% binder material. Examples of particulate insulating filler materials are vermiculite, perlite, flyash, volatilized silica and mixtures thereof. These materials are silica- and silica-based materials, with SiO₂ contents of 36-42%, 70-75%, 40-55% and 100%. Vermiculite, perlite and flyash moreover contain significant amounts of alumina. Overall, these renders the particulate filler materials similar in chemical composition to the basic material of the microporous powder composition, i.e. pyrogenic silica and pyrogenic alumina. Still, the addition of 12% thereof had a significant effect on the shrinkage after a 24 hours heat treatment at 900° C. Without filler this shrinkage was less than 2.0%. With volatilized silica as filler, it was 5.5% When using 12% of precipitated silica, it was even 7.1%.

Especially for the granulates, but also for other insulation products, it is desirable to arrive at a powder composition with sufficiently low thermal conductivity and with an acceptable price. Some fillers or binders that may be applicable, however would increase the thermal conductivity, and not just at room temperature, but also at operation temperatures of heaters, motors and the like, which may easily go up to 400° C. or above. That low conductivity is a concern for granules, which typically have a higher thermal conductivity than the panels or the VIPs.

### SUMMARY OF THE INVENTION

It is therefore a first object of the invention to provide an improved microporous powder composition, which is suitable for generation of granules and which will have a sufficiently low thermal conductivity at temperatures up to at least 400° C.
It is another object of the invention to provide a method of manufacturing insulation products using the improved microporous powder composition.
It is a further object of the invention to provide insulation products comprising the improved microporous powder composition, in particular in the form of granulates.
According to a first aspect, the invention provides a microporous powder composition, comprising an insulation powder chosen from alumina and silica, an opacifier and a filler, wherein the filler is a gypsum material.
According to a second aspect, the invention provides use of the microporous powder composition of the invention for the manufacture of insulation products, for instance in granular form.
According to a third aspect, the invention relates a method of manufacturing of an insulation product, comprising the steps of (1) providing the microporous powder composition of the invention (2) compressing or compacting said microporous powder composition and (3) processing said microporous powder composition into an insulation product.
According to a fourth aspect, the invention relates insulation products comprising the microporous powder composition of the invention.
It has been observed in experiments that gypsum is very suitable as filler for a microporous powder composition. It has little impact on performance with good processing or even improved processing of the powder composition, such as during mixing, compaction or compression.

In a preferred embodiment, at least part of the crystalline gypsum material is crystalline gypsum is needle-shaped. More preferably, the crystalline material is predominantly needle-shaped, thus comprising at least 30 vol %, such as at least 40 vol % needle-shaped crystalline material. Needle-shaped material is deemed most beneficial as a processing aid during compression or compaction of the microporous powder composition, and particularly during roller-compaction, wherein the microporous powder composition is compacted with a predetermined pressure between two rollers that typically run in opposite directions. The inventor believes, without desiring to be bound therewith, that needle-shaped crystals may distribute pressure and hence prevent damage to the porous powder particles. In addition to avoiding damage, this may be further exploited to operate the compaction process, such as the roller-compaction process, at operation conditions allowing to reach a material with a lower density, which will have better insulation performance.

In another embodiment, use is made of gypsum material with a mean size (d50) in the range of 10-100 μm as measured with laser diffraction. More preferably, the mean size (d50) is in the range of 20-75 μm. Good results have been obtained with gypsum having a mean size (d50) in the range of 30-50 μm. It is surprising that a combination of fine, microporous material with comparatively big gypsum particles provide good results with respect to insulation performance. It is observed herein that microporous material typically has a primary particle size of typically a few nanometers. The primary particles constitute aggregates including microporous voids in the order of 100 nm. The opacifier is also typically at least partially present in the sub-micrometer range. The inventor believes, without desiring to be bound therewith, that the combination of such large gypsum particles with fine silica material results in a specific order or microstructure within the material. For instance, an encapsulation of the gypsum particles may be formed, resulting therein that the individual gypsum particles are isolated from each other, and as a consequence that the thermal conductivity is defined by the microporous phase in the material. Such understanding is deemed supported by the measured thermal conductivities and also the small shrinkage after a heat treatment.

In a further implementation, the gypsum material has an aspect ratio of length to width of at most 5. The width is herein seen as the smallest size, such that the aspect ratio is necessarily at least one. In a preferred implementation the aspect ratio is at most 3. Such a shape is deemed beneficial for processing of the material.

In one embodiment, the gypsum material is or comprises predominantly (in a minimum weight percentage of 60%, preferably 70% or 80% or even 90% with respect to the total amount of gypsum), gypsum dihydrate, when provided as a fresh product. Gypsum dihydrate is a conventional form of gypsum material with formula CaSO₄·2H₂O. Gypsum dihydrate has a needle-shaped crystal shape. The use of needle-shaped crystalline material is deemed positive, as it may stabilize the powder composition during a compaction or compression step during the processing. It is known that gypsum dihydrate has limited temperature stability, but processing of microporous powder mixtures typically occurs without any specific heating, thus at room temperature or slightly above. Moreover, if during operation temperatures go up and the dihydrate may convert into other hydrates such as the hemihydrate or the anhydrate, the liberated water does not cause trouble, as it may be partially absorbed by other ingredients of the powder composition, such as the insulation powder which is preferably silica. Moreover, such liberated water may evaporate and remove out of the insulation product, particularly when the insulation product is not present in a package constituting a barrier for water vapour. One such form of the insulation product without any barrier for water vapour removal is a granulate.

In another embodiment, the gypsum material is or predominantly comprises (in a minimum weight percentage of 60%, preferably 70% or 80% or even 90% with respect to the total amount of gypsum), gypsum hemihydrate, when provided as a fresh product. Gypsum hemihydrate is known under the formula CaSO₄·0.5H₂O. It is not excluded that during operation the gypsum hemihydrate may convert into another hydrate, such as anhydrate. Gypsum hemihydrate has temperature stability up to at least 400° C., and even beyond when dispersed in a powder mixture. This enables that the material is stable up during most operation temperatures, and therewith that no changes will occur that might have any impact on the insulation performance, particularly some change in the thermal conductivity. Gypsum hemihydrate is moreover available in a needle-shaped crystal form, particularly the so-called alpha-form, which is deemed beneficial for processing. Moreover, any out-diffusion of water vapour is limited in compared to the gypsum dihydrate, as the hemihydrate contains only one fourth of the water as the dihydrate.

In again another form, gypsum material is or predominantly comprises (in a minimum weight percentage of 60%, preferably 70% or 80% or even 90% with respect to the total amount of gypsum), gypsum anhydrite. This anhydrite has very good temperature stability, in line with the temperature stability of microporous powders. It will not covert to another hydrate under liberation of water. Hence, this anhydrate is suitable for use in insulation products comprising a barrier that does not allow out-diffusion of water vapour, and also in substantial amounts, for instance at least 10% based on the weight of the microporous powder composition.

It is observed for sake of clarity that the wording of predominant composition of the gypsum is used, as any supplied gypsum material may include some further hydrate forms in addition to the main one present. In a further embodiment, however, mixtures of the dihydrate, hemihydrate and anhydrite forms of gypsum may be used. Such a mixture may achieve improved temperature stability of the thermal conductivity in combination with the presence of sufficient needle-shaped crystals that may support processing. Also the water vapour generation may be limited.

Preferably, the gypsum material is used in a purity of at least 80% by weight. Being a natural material, gypsum may comprise other ingredients than calcium sulphate. Both for sake of minimizing the impact on the insulation performance and for sake of avoiding any unexpected processing issues, it is preferable to limit the amount of other ingredients. More preferably, the gypsum material is used in the microporous powder composition with a purity of at least 90% by weight, or even with a purity of at least 95% by weight. A preferred source of such gypsum material is so-called synthetic gypsum, which results from industrial product, particularly as a by-product of other industrial processes. The most common and preferred form of synthetic gypsum is FGD gypsum, formed from coal-fired power plants and more particularly by means of flue gas desulfurization. However, synthetic gypsum can also be generated through various acid-neutralizing processes. Additional types of synthetic gypsum include titanogypsum, phosphogypsum, fluorogypsum, and citrogypsum. Natural gypsum, and/or any gypsum waste material from a gypsum dry wall manufacturing plant, may alternatively be used.

In one embodiment, the gypsum filler is present in an amount of 1 to 50 weight percent, based on total dry weight of the microporous powder composition. At the lower end of the range, for 1-10 weight percent, the gypsum filler may contribute to the processing of the powder composition. At a higher end of the range, typically from 20-50 weight percent, the addition leads to a significant decrease in cost price without a corresponding decrease in loss of insulation performance. Preferably, the gypsum filler material will reduce the amount of insulation powder without reduction of the amount of opacifier. However, at a higher end of the range, some reduction of the amount of opacifier are foreseen.

In a further embodiment, the gypsum filler is present in an amount of 10 to 25 weight percent, based on total dry weight of the microporous powder composition. Good results have been achieved in preliminary experiments with powder compositions comprising gypsum within this range, without need of much adjustment of processing and without major change in the insulation performance.

In one implementation, gypsum is the only filler that is used in the microporous powder composition. In a further implementation, other fillers or binders may be used as part of the microporous powder composition. Some examples of these fillers and binders are water glass, precipitated and amorphous silica, calcium silicate, basic oxides such as magnesium oxide, calcium oxide and barium oxide. While one filler is deemed preferred so as to keep the powder composition and its processing simple, other fillers are not excluded and may even be present within the gypsum material as a contaminant. Preferably, such further fillers are present in an amount not exceeding the amount of the gypsum material and more preferably less than the gypsum filler.

In one embodiment, at least 50% by weight of the insulation powder is chosen from the group selected from pyrogenic silica, pyrogenic alumina or combinations thereof. Preferably, at least 80% by weight of the insulation powder is chosen from the group selected from pyrogenic silica, pyrogenic alumina or combinations thereof. Hence, the insulation powder is preferably a pyrogenic powder instead of an aerogel. Moreover, the amount of non-pyrogenic forms of silica or alumina, such as precipitated silica, microsilica and silica fuse, is at most 50% by weight, and preferably at most 20% by weight. Such non-pyrogenic forms of silica may be suitable for products intended for use at lower temperatures, for instance up to 300° C., but the insulation performance quickly deteriorates upon heating. When the amount of non-pyrogenic forms of silica and alumina is at most 20%, insulation performance can be preserved. In such case, thermal conductivity will increase, but generally less than 10% increase. The temperature limit, i.e. the maximum temperature at which the material may be used without significant deterioration is comparable. Of all non-pyrogenic forms of silica, precipitated silica is most preferred, since it has a comparatively large specific surface area and presence of micropores is assumed. Preferably, at least 90% by weight of the insulation powder is chosen from the group of pyrogenic silica, pyrogenic alumina or combinations thereof. Pyrogenic silica is the name for pyrogenically prepared silicic acids. Alumina, if used, is preferably prepared analogously.

In a preferred implementation, the insulation powder is pyrogenic silica. It is for instance present in an amount of 30 to 90 weight percent, and preferably 40 to 80 weight percent, based on total dry weight of the microporous powder composition. Pyrogenic silica is the name for pyrogenically prepared silicic acids and may include for instance silicic acid, precipitated low-alkali silicic acids, silicon dioxide aerogels. Alumina, if used, is preferably prepared analogously. Microporous powder compositions comprising pyrogenic silica may have a temperature stability up to 1000° C., and have been found appropriate for granulation. If a temperature stability to higher temperatures would be desired, alumina is to be added or used. Particle sizes of the insulation powder is for instance between 2 and 300 nanometers, with a particle size between 4 and 100 nm being more common and a particle size between 4 and 20 nm most common.

In another embodiment, the insulation powder comprises or is a silica aerogel material. Such silica aerogel material may be hydrophobic. Such material is for instance prepared in the manner disclosed in WO2016/054254A2, which is included by reference. While a variety of aerogel materials exist, a silica aerogel (in said patent application referred to as an aerogel composition comprising a silica-based framework) is beneficial for its insulating value. However, its thermal stability is limited. As indicated in said patent application, thermal decomposition would generally start in the temperature range of 300 to 700° C., and in a most preferred embodiment in the range of 500° C. to 650° C. This limited temperature stability is not problematic in some applications, but rather undesired in other applications, for instance, wherein granules are used in heating systems, in heat storage systems, directly adjacent to motors, reactors or vessels configured for high temperature materials.

Opacifiers for use in microporous powder compositions are known, and for instance include titanium oxide, ilmenite, iron (II), iron (III) mixed oxides, chromium dioxide, zirconium oxide, manganese oxide, iron oxide, aluminium oxide, zirconium silicate, silicon carbide. Silicon carbide is a preferred opacifier.

In one further implementation, the microporous powder composition is free from reinforcing fibers. Such fibers are conventionally used to strengthen panel- or block-shape type insulation products. However, in case that the microporous powder composition is used in granules, such as made by dry granulation using roller-compaction, the addition of fibers into the microporous powder composition is not desired, as it may interfere with the processing, and hence the microporous powder composition is preferably free from such fibers. As fibers are not desired, it is surprising that the addition of crystals, such as needle-shaped crystals is not detrimental for the granulation process of the microporous powder composition.

In one implementation, the microporous powder composition comprises the opacifier in an amount of 10-50 wt %, the insulation powder in an amount of 40-80 wt % and said filler in an amount of 1-50 wt %. This has been observed to provide an acceptable powder composition for granulation. Preferably, the powder composition is free of any reinforcing fibers. More preferably, the microporous powder composition comprises the opacifier in an amount of 15-35 wt %, the insulation powder in an amount of 40-80 wt % and said filler in an amount of 5-30 wt %.

In an embodiment according to the invention, the insulation product is in the form of a granulate. Such a product is beneficial, as it may be used by a customer to fill a space, of any simple or complex shape, with the granulate, and therewith generate an insulating layer. In one preferred implementation, the granulate insulation product is used for thermal insulation of heating systems, storage heaters, motors, reactors and/or vessels configured for operation at a high temperature, for instance above 200° C., preferably above or with peak temperatures above 400° C., more preferably above and/or with peak temperatures above 600° C. When intended for use at temperatures of 300° C. and higher, particularly of 400° C. and higher, the insulation powder preferably comprises at least one of pyrogenic silica and pyrogenic alumina, more preferably in an amount of at least 90% by weight of the insulation powder. More preferably, the insulation powder consists of at least one of pyrogenic silica and pyrogenic alumina, for such very high temperature applications.

The granule size is in one implementation in the range of 0.25 to 3.0 mm, as defined by sieving. In an advantageous implementation, the granule size is in the range of 0.25 to 2.5 mm, as defined by sieving. This has been found to be a useful range, creating an optimum between limited dust and appropriate degree of filling and hence insulation value in the ultimate application. Preferably at least 70% by weight of the granules have a size in the range between 0.25 mm and 2.00 mm. In one further embodiment, the granule size is chosen in the range of 0.40 to 2.5 mm, as defined by sieving. In again a further embodiment, the granule size is chosen to be in the range of 0.50 to 2.5 mm, as defined by sieving. The minimum size range may even be 0.8 mm or 1.0 mm.

In a further implementation, the amount of dust being material smaller than 0.25 mm, as defined by sieving, is less than 10% by weight based on the weight of the granules. Preferably, the amount of dust is less than 8 weight percent or even at most 7 weight percent. It has been observed that the addition of the gypsum filler does not increase the amount of dust. In order to decrease the level of dust, the granule size may be optimized, but also a post-treatment may be done onto the granules, for instance with a silicic acid material, such as waterglass. Such a post-treatment may further increase the strength of the granules.

In one implementation, the microporous powder composition is used in a granulate has a nominal tap density of at most 250 g/l. Preferably, the nominal tap density is at most 220 g/l, preferably at most 200 g/l, even in the range of 170-190 g/l. Lowering the tap density may be achieved by adaptation of the pressure applied in the roller-compaction step of the dry granulation. Herein, the gypsum filler may contribute to achieving the lower densities. Such lower densities are desired, as the thermal conductivity decreases with the density.

Granulation of the microporous powder composition to granules is preferably performed by dry granulation, and more preferably using a roller-compaction step. A roller compaction step involves the use of equipment provided with at least two counter-rotating rollers, between which the powder composition is continuously compressed using a controlled compaction force. The granule size is defined in a subsequent size reduction step, for instance in a sieve mill. Particles below the size limit of a sieve screen of the sieve mill, or in a separate sieve downstream of the mill may be recirculated to the roller-compactor used in the roller-compaction step.

Optionally, a water-repellent and/or hydrophobation agent may be applied for control of humidity level. The application may be as part of the powder composition and/or as a post-treatment of the granules. The water-repellent or hydrophobic agent may further be applied during or directly subsequent to manufacture of the pyrogenic silica. Examples of agents are siloxanes, waxes and silicone resins, the latter typically provided in the form of an emulsion in water. The amount of such agent may be low, typically less than 0.5% by weight of the granules. Concentrations up to 0.3% by weight or even up to 0.2% by weight may be feasible.

The granulate of the invention can be used for thermal insulation. The granulate can preferably be used in insulation mixtures or formulations. The corresponding thermal insulation mixtures and/or formulations may comprise at least one solvent and/or binder and/or a filler.

The solvent may be selected from the group consisting of water, alcohols, aliphatic and aromatic hydrocarbons, ethers, esters, aldehydes, ketones and mixtures thereof. Solvents used may, for example, be water, methanol, ethanol, propanol, butanol, pentane, hexane, benzene, toluene, xylene, diethyl ether, methyl tert-butyl ether, ethyl acetate, acetone.

The binder may comprise organic or inorganic substances. The binder preferably comprises reactive organic substances. Organic binders may be selected, for example, from the group consisting of (meth)acrylates, alkyd resins, epoxy resins, gum arabic, casein, vegetable oils, polyurethanes, silicone resins, wax, cellulose gum. Such reactive organic substances can lead, for example, via polymerization, crosslinking reaction or another type of chemical reaction, to curing of the thermally insulating formulation used and/or of the thermally insulating mixture.

Additionally or alternatively to the organic binder, the thermally insulating formulation and/or the thermally insulating mixture may comprise inorganic curable substances. Inorganic binders, also referred to as mineral binders, have essentially the same function as the organic binders: that of binding admixtures to one another. In addition, inorganic binders are divided into non-hydraulic binders and hydraulic binders. Nonhydraulic binders are water-soluble binders such as white lime, dolomite lime, gypsum and anhydrite, which cure solely under air. Hydraulic binders are binders that cure under air and under water and are insoluble in water after curing. These include hydraulic limes, cements, and render and masonry binders.

It is observed for clarity that any of the embodiments discussed hereinabove, specified in dependent claims and/or apparent from the examples are deemed applicable to any of the aspects of the invention. Parameter values given in the present specification are measured in accordance with the methods specified hereinbelow, unless otherwise indicated or known per se. Any reference to the weight percentage herein expressed as wt. % or % by weight refers to the same. The reference is the total powder composition, which is a dry composition, unless otherwise indicated.

### EXAMPLES AND FIGURES

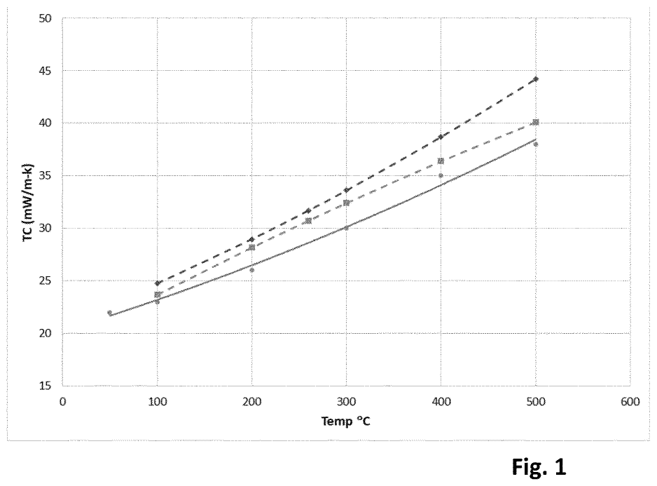

These and other aspects of the invention will be further elucidated in following examples. FIG. 1 is a graph of experimental data obtained in accordance with Example 2 showing the thermal conductivity (TC) as a function of temperature.

### Measurement Methods

Compressive strength is measured in following manner: granules are pressed into a metal die. A universal test machine of 500 kN load cell is used with cross head speed of 1 mm/min. The maximum force and displacement are recorded continuously during compression and the stress is calculated therefrom.

Tap or tapped density is an increased bulk density attained after mechanically tapping a receptacle containing the sample of powder or granule. The tapped bulk density is obtained by mechanically tapping a graduated measuring cylinder or vessel containing the sample. After observing the initial untapped bulk volume (V0) and mass (m0) of the sample, the measuring cylinder or vessel is mechanically tapped, and volume or mass readings are taken until little further volume or mass change is observed. The mechanical tapping is achieved by raising the cylinder or vessel and allowing it to drop, under its own mass, a specified distance. Devices that rotate the cylinder or vessel during tapping may be preferred to minimize non-uniformity during tapping down.

Thermal conductivity is measured at equilibrium using a cell with a diameter of 110 mm and a height of 100 mm. A heat source in the form of a cylindrical heating element is hanged in the middle with controlled power supply. Insulation is present circumferential to the cylindrical heating element. At the outside, a metal can is present. The thermal conductivity of the material is obtained from the temperature difference (between hot/cold face temperatures) and heat transfer cross cylindrical section. An effective area for the heat transfer is calculated, and hot & cold face temperatures (HF, CF) are recorded. The thermal conductivity γ in mW/mK is calculated as γ=0.956×Power supply/ΔT (HF−CF)−0.0036. This method has been developed by applicant in collaboration with the National Physical Laboratory (NPL) in the UK. The resulting values for the thermal conductivity are approximately 15% higher than those measured in accordance with ISO 8302.

Shrinkage is dimensional shrinkage of alumina crucibles of fixed size. The crucibles are filled up to the top to settlement density. The filled crucible is put into the furnace during 24 hours at 1000° C. Then, the furnace is switched off, and cooled down to temperature (typically within 30 minutes). The height drop of the granules and crucible is measured as the shrinkage value for the product.

### Example 1

Microporous powder compositions were generating by mixing pyrogenic silica as insulation powder, and silicon carbide as opacifier and optionally a filler. The pyrogenic silica had a specific surface area in the range of 200-250 m2/g as measured by the BET method and was hydrophilic (i.e. not treated with a hydrophobation agent). The powder compositions were thereafter subjected to dry granulation, which comprises a roller-compaction step using equipment provided with at least two counter-rotating rollers, between which the powder composition is continuously compressed using a controlled compaction force. The compaction force or pressure was set to achieve a desired tap density, which was 240 g/l in the examples. The bulk density was 200 g/l. The dry granulation furthermore included a size reduction step downstream of said roller-compaction step. Use was made of a sieve mill. The final sieve size in the sieve mill was set to 310 microns. The granule size was such that at least 70 wt % of the granules had a size within the range 0.25 mm and 2.00 mm. In all examples, the granule formation was identical.

In examples of the invention, the powder composition was modified by inclusion of a filler. The amount of filler was 20%, the amount of pyrogenic silica was 50% and the amount of opacifier was 30%, all in weight percent. In the reference example, the amount of filler was 0%, the amount of pyrogenic silica was 70% and the amount of opacifier 30%. As fillers, gypsum and perlite were tested. All samples were granulated to a tap density of 240 g/l and a bulk density of 200 g/l. The gypsum material was a synthetic gypsum material with a purity of 96%. The material was gypsum dihydrate and was crystalline having needle-shaped crystals. The perlite was a perlite microsphere obtained from Siniat, comprising 80% SiO2 and 13% Al2O3, 5% K2O and 3% Na2O (the total being 100%). The bulk density was 115 kg/m3 and the d50 (mean size) was 70 μm. Perlite microspheres are a special subset of perlite fillers and require advanced manufacturing and classification techniques to produce. They consist of discreet hollow spheres of expanded perlite-generally between 10 and 300 micrometer in size. Densities vary from 96 to 450 kg/m3. The used perlite microspheres had a very high purity. Typically, expanded perlite further comprises minor quantities of up to 1% or 2% of Titanium dioxide, Magnesium oxide, Iron oxide (Fe2O3) and Quick lime (CaO), which contaminations deteriorate the insulation properties.

TABLE 1
Test results

| | Example | | | | |
|---|---|---|---|---|---|
| | Reference | 1 | 2 | 3 | Comparative |
| | Filler | | | | |
| | | | | | Perlite |
| | None | Gypsum | Gypsum | Gypsum | microspheres |
| Filler (%) | 0 | 5 | 10 | 20 | 20 |
| pyrogenic | 70 | 65 | 60 | 50 | 50 |
| silica (%) | | | | | |
| Thermal | 30 | 31 | 32 | 30 | 32 |
| conductivity at | | | | | |
| 200° C. | | | | | |
| (mW/m · K) | | | | | |
| Thermal | 40 | 42 | 43 | 46 | 46 |
| conductivity at | | | | | |
| 400° C. | | | | | |
| (mW/m · K) | | | | | |
| Dust (wt %) | 7% | 7% | 7% | 7% | 9% |
| Granule strength | 155 | 156 | 157 | 159 | 159 |
| (kPa) | | | | | |
| Shrinkage after | <3 | <3 | <3 | <3 | <5 |
| 24 hours heating | | | | | |
| treatment at | | | | | |
| 1000° C. (%) | | | | | |

The results in Table 1 indicate that gypsum is effective as a filler. The increase in thermal conductivity at 200° C. and 400° C. is very limited to limited. An alternative filler, low-density perlite microspheres, was found to increase the thermal conductivity at 200° C. already and also at 400° C. Moreover, the dust level of the granulate with the perlite microspheres increased and the shrinkage at 1000° C. of that material was higher. It is observed that the shrinkage is particularly advantageous when compared to data provided in WO2006/097688A1. In the said patent application, shrinkage was identified after a 24 hours heat treatment at 900° C., whereas the heat treatment of the present examples was carried out at 1000° C. The shrinkage after a heat treatment at 900° C. would be 1-2% lower.

Based on these preliminary experiments, the microporous powder composition and the granulation process may be further optimized, for instance to achieve a lower density with lower thermal conductivity. Furthermore, the gypsum type may be varied, so as to achieve less variation at 400° C. Particularly for the 20% addition, it appears that the conversion from the dihydrate into hemihydrate crystals increases the thermal conductivity. Hence, use of hemihydrate, which is stable up to at least 400° C. will stabilize the result.

The results on thermal conductivity are surprising, given the relatively high thermal conductivity of gypsum dihydrate. S. Manzello et al, Proc. Of 5th Int. Conference on Structures in Fire (SiF'08), 2008, pp. 656-665 (https://tsapps.nist.gov/publication/get_pdf.cfm?pub_id=900117) specify a thermal conductivity at room temperature in the range of 250-300 mW/mK (virgin material) and at 400° C. in the range of 150-200 mW/mK for a gypsum board. The lower thermal conductivity at 400° C. is attributed to the dehydration of the gypsum in a first heating cycle. The inventor believes, without desiring to be bound herewith, that the mutual ordering of the gypsum and the pyrogenic silica may provide an explanation therefore. In his understanding, the gypsum particles with their comparatively big size would be encapsulated by the pyrogenic silica (and the opacifier), similar to micelles in an emulsion. As a consequence, there would not be a direct path between gypsum particles. Rather any heat (in the form of molecular vibrations and/or radiation) would be transmitted via the microporous phase.

The preliminary results on shrinkage after a 24 hours heat treatment at 900° C. are surprising too, in view of its low value of less than 3%. This value is much smaller than the values observed in WO2006/097668A1 for 12% volatilized silica and 12% precipitated silica, leading to a shrinkage of 5.5% and 7.1% respectively. The performance is also better than that of the composition comprising perlite microspheres.

### Example 2

A further experiment was performed, using microporous powder composition comprising 0% (reference), 10% and 17.5% gypsum material as a filler. The reference sample contained 70% pyrogenic silica and 30% SiC opacifier. The first sample contained 10% gypsum dihydrate material in addition to 60% pyrogenic silica and 30% SiC opacifier. The further sample contained 17.5% gypsum material as a filler in addition to 52.5% pyrogenic silica and 30% SiC opacifier. The microporous powder compositions were processed to obtain a bulk density in the range of 204-210 g/l.

Thermal conductivity values were measured over the temperature range from 100° C. to 500° C. Results are shown in FIG. 1. The thermal conductivity increases marginally at 200° C. from 28.0 mW/m·K for the reference to 29.0 mW/m·K for the further sample. At 400° C., the increase is from 36 mW/m·K for the reference to 39 mW/m·K for the further sample including 17.5% gypsum. It is apparent from FIG. 1 that the increase in thermal conductivity with increasing temperature is almost linear both for the reference sample and the first sample with 10% gypsum material, and that the line through the measured values is not more steep for the first sample than for the reference sample. It seems that the first sample behaves better at 400-500° C. than at 200-300° C. This may be due to a conversion of gypsum dihydrate to hemihydrate and/or anhydrite. The linearity is slightly less for the further sample with 17.5% gypsum, suggesting that the thermal conductivity increase at higher temperatures than 400° C. will be higher.

### Example 3

A further characterization was performed to indicate the effective effect on temperature for isolation of a high temperature vessel. Thereto, a cylindrical high temperature metallic vessel of an approximate diameter of 1 meter was used. An annular space of approximately 76 mm (3″) is created around the vessel, to accommodate an insulation material, using an outer jacket of sheet metal or other high temperature material. The purpose of the insulation and outer jacket is to minimize heat loss from the vessel, in a minimal thickness, to conserve energy and protect surround components or personnel from high temperature exposure.

A calculation was performed using the method defined in ASTM C680 “Standard Practice for Estimate of the Heat Gain or Loss and the Surface Temperatures of Insulated Flat, Cylindrical, and Spherical Systems by Use of Computer Programs”. This practice is an iterative algorithm which calculates the heat loss and outside surface temperature for an insulated system once it reaches a steady state condition. The time to reach this stead state condition is not calculated as the steady state condition is considered to be the worst case condition (highest temperature and heat loss). The ASTM C680 method defines a hot face temperature of 875° C. (e.g. super-heated steam), an interior heat flux of 150 W/m²K, an exterior surface emissivity of 0.30 (e.g. stainless steel sheet metal) and an external ambient temperature of 25° C. There is no external wind flow (natural convection only), and the 1 meter diameter cylinder is oriented vertically. Results are shown in Table 2, which also lists thermal conductivities. Table 3 provides the same data as increases relative to the reference values.

TABLE 2
test data (absolute values)

| | | Heat | Cold face | Temperature | Thermal | Thermal |
|---|---|---|---|---|---|---|
| | Gypsum | loss | temperature | increase to | conductivity at | conductivity at |
| Sample | content | (W/m²) | (° C.) | ambient (° C.) | 200° C. (mW/mk | 400° C. (mW/mk |
| Ref | 0% | 355 | 73 | 48 | 28.0 | 36.0 |
| First | 10% | 372 | 75 | 50 | 28.2 | 36.4 |
| Further | 17.5% | 412 | 79 | 54 | 29.0 | 38.7 |

TABLE 3
relative increases for gypsum additions.

| | | | Temperature | Thermal | Thermal |
|---|---|---|---|---|---|
| | Gypsum | Heat | increase to | conductivity at | conductivity at |
| Sample | content | loss | ambient | 200° C. (%) | 400° C. (%) |
| Ref | 0% | — | — | — | — |
| First | 10% | 4.8% | 4% | 0.7% | 1.1% |
| Further | 17.5% | 16% | 12% | 3.6% | 7.5% |

The table demonstrates that the loss of insulation value for the gypsum additions is small. The relative increase in values for the sample with 10% gypsum is overall less than 5% and only around 1% for the thermal conductivity values. For the sample with 17.5% gypsum, all values are again lower than the 17.5%. Based herein, it is apparent that the preferred range of the gypsum addition for a high temperature application of close to 900° C. is in the range of up to 15% by weight, more preferably up to 12% by weight, such as from 8-12% by weight.

Thus, in summary, the invention relates to microporous powder composition, comprising an insulation powder chosen from alumina and silica, and an opacifier and a filler, wherein the filler is a gypsum material. The gypsum material may be gypsum dihydrate, gypsum hemihydrate or gypsum anhydrite. It may be synthetic gypsum or natural gypsum or a combination of both. The microporous powder composition comprises the opacifier in an amount of 10-50 wt %, the insulation powder in an amount of 40-80 wt % and the filler in an amount of 1-50 wt %. The microporous powder composition is used in insulation products, such as granulates.

1. A microporous powder composition, comprising an insulation powder chosen from alumina and silica, and an opacifier and a filler, wherein the filler is a gypsum material.

2. The microporous powder composition of claim 1, wherein the filler is a gypsum dihydrate.

3. The microporous powder composition of claim 1, wherein the gypsum material is crystalline.

4. The microporous powder composition of claim 3, wherein at least part of said crystalline gypsum is needle-shaped.

5. The microporous powder composition of claim 1, wherein the filler is present in an amount of 1 to 50 weight percent, based on total dry weight of the microporous powder composition.

6. The microporous powder composition of claim 5, wherein the filler is present in an amount of 10 to 25 weight percent, based on total dry weight of the microporous powder composition.

7. The microporous powder composition of claim 1, wherein the gypsum material has a mean particle size (d50) in the range of 10-100 μm as measured by laser diffraction.

8. The microporous powder composition of claim 1, wherein the gypsum material has particles with an aspect ratio of length to width from 1 to 5.

9. The microporous powder composition of claim 1, wherein the insulation powder is pyrogenic silica.

10. The microporous powder composition of claim 1, wherein microporous powder composition is free of fibers.

11. An insulation product comprising the microporous powder composition of claim 1, wherein the microporous powder composition is in a compressed or compacted form.

12. The insulation product of claim 11, wherein the insulation product is a granulate.

13. Use of the microporous powder composition of claim 1 for the manufacture of an insulation product, wherein the manufacture comprises granulation.

14. The use of claim 13, wherein the granulation comprises a roller compaction step.

15. The use of claim 14, wherein the granulation is configured to provide granules with a granule size in the range of 0.2 to 3 mm, as defined by sieving.

16. The use of claim 13, wherein the granules are manufactured with a tap density of less than 250 g/l.

17. The microporous powder composition of claim 4, wherein the needle-shaped crystalline gypsum is at least 30 vol %.

18. The microporous powder composition of claim 9, wherein the pyrogenic silica insulation powder is present in an amount of 40 to 80 weight percent, based on the total dry weight of the microporous powder composition.

19. The use of claim 14, wherein the granule size of the granules is in the range of 0.3 to 2.5 mm.

20. The use of claim 13, wherein the granules are manufactured with a tap density of between 200 and 203 g/l.
